(19) United States
(12) Patent Application Publication
(10) Pub. No.: US 2018/0250979 A1
(43) Pub. Date: Sep. 6, 2018

(54) METHODS OF PRESENTING USER-INTERACTIVE CUSTOMIZED GRAPHICAL CONTENT

(71) Applicant: Kelly J. Taylor, Long Beach, CA (US)

(72) Inventor: Kelly J. Taylor, Long Beach, CA (US)

(21) Appl. No.: 15/448,658

(22) Filed: Mar. 3, 2017

(51) Int. Cl. B43L 1/00

(52) U.S. Cl. CPC B43L 1/002

(57) ABSTRACT

This disclosure relates to a method of presenting user interactive graphical content. More specifically, the disclosure relates to presentation of a writeable surface covering including a base layer displaying graphical content and a transparent layer applied to the base layer. Users may add user content to the writeable surface covering, such as, by writing or drawing on the covering using dry erase markers other suitable writing implements. The user content may overlay the graphical content without marring the graphical content, and the user content may later be erased from the writeable surface covering. The writeable surface covering may be adhered or otherwise attached to a wall or other support surface.

### FIELD OF THE INVENTION

This disclosure relates to a method of presenting user interactive graphical content. More specifically, the disclosure relates to presentation of a writeable surface covering including a base layer displaying graphical content and a transparent layer applied to the base layer. Users may add user content to the writeable surface covering, such as, by writing or drawing on the covering using dry erase markers or other suitable writing implements. The user content may overlay the graphical content without marring the graphical content, and the user content may later be erased from the writeable surface covering. The writeable surface covering may be adhered or otherwise attached to a wall or other support surface.

### BACKGROUND OF THE INVENTION

Writeable surfaces, such as dry erase boards or chalk boards, provide a user with a surface which can be written upon and later erased. Certain writeable surfaces include gridlines or calendars permanently printed on the surfaces to facilitate alignment of user content written or drawn on the surfaces. Traditional dry erase boards or chalk boards are embodied in boards designed for hanging on walls or free-standing boards mounted on easels or other support frames. More recently, writeable surfaces have been offered which can be removably applied to walls or other supports using adhesives.

### SUMMARY

The disclosed methods for presenting user-interactive graphical content addresses these challenges and provides multiple benefits to a user. In some embodiments, the disclosed methods include applying a writeable surface covering to a wall in a conference room, office, or hallway in a commercial office space. The writeable surface covering may display company logos, brands, trademarks, service marks or other graphical content. Individuals may write atop the graphical content to facilitate dissemination of ideas and collaboration within the workplace. The display of graphical content may also be used for internal and external brand messaging. In other embodiments, the writeable wall covering may display graphics depicting a rival company, person, sports team, or other entity, and users may write upon the covering to express their opinions of the rival.

Embodiments of the present invention relate to methods for presenting user-interactive content. In some embodiments, the present invention comprises a method of presenting user-interactive graphical content, the method comprising providing a writeable surface covering displaying graphical content, applying the writeable surface to a support surface accessible to a user, and providing means for applying user content to the writeable surface covering. In some embodiments, the writeable surface covering includes a base layer including a first surface and a second surface opposite the first surface, and a transparent layer including a front surface and a rear surface, the rear surface attached to the first surface of the base layer. In further embodiments, the graphical content is printed on the first surface of the base layer prior to attachment of the transparent layer to the base layer. In certain embodiments, applying the writeable surface covering to the support surface comprises affixing the second surface of the base layer to the support surface. In some embodiments, affixing the second surface of the base layer to the support surface comprises adhering the second surface of the base layer to the support surface. In further embodiments, the support surface is a wall. In certain embodiments, the support surface is located in a commercial building. In some embodiments, the graphical content includes a first design and a second design. In further embodiments, the first design is selected from a collection of first designs. In certain embodiments, the writeable surface covering includes a base layer including a first surface and a second surface opposite the first surface, and a transparent layer including a front surface and a rear surface, the rear surface attached to the first surface of the base layer, and wherein the transparent layer is attached to the base layer after the second design is printed on the first surface, and wherein the second design is printed on the first surface after the first design is printed on the first surface. In some embodiments, the user content includes words, indicia or drawings written on the writeable surface covering. In further embodiments, the means for applying user content includes writing implements. In certain embodiments, the writing implements are dry erase markers. In some embodiments, the user content is erasable from the writeable surface covering.

In further embodiments, the present invention comprises a method of eliciting feedback on graphical content, comprising forming a writeable surface covering by printing graphical content on a first surface of a base layer, then applying a transparent layer to the first surface, adhering the writeable surface covering to a support surface accessible to a user, providing means for applying user content to the writeable surface covering. In some embodiments, the base layer is a cast film. In further embodiments, the transparent layer is comprised of polyethylene terephthalate. In certain embodiments, the writeable surface covering is sized to substantially cover the entirety of the support surface. In some embodiments, the graphical content includes a first design and a second design, wherein the second design is printed on the base layer after the first design is printed on the base layer. In further embodiments, the graphical content is printed using a gel printer.

The disclosed method of presenting user-interactive graphical content has several advantages over simply providing a dry erase board or chalk board with the graphical content written thereon. Traditional dry erase boards or chalk boards are embodied in boards designed for hanging on walls or free-standing boards mounted on easels or other support frames. Such boards could easily be stolen when placed on the exterior of a building or other support surface accessible to the general public. In contrast, the disclosed writeable surface covering is preferably adhered to the support surface and would be as difficult to remove and steal as traditional wallpaper. Another advantage of the present invention is that graphical content written on traditional dry erase boards or chalk boards can be easily erased. The graphical content in the present invention is applied to the base layer beneath the transparent layer, and is not accessible to the user. User content written or drawn on the transparent layer remains easily eraseable.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present invention will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 depicts a side view of an embodiment of a writeable surface covering;

FIG. 2 depicts a stylized perspective view of a writeable surface covering;

FIG. 3A depicts a blank base layer;

FIG. 3B depicts the base layer of FIG. 3A with a first design printed thereon;

FIG. 3C depicts the base layer of FIG. 3B with a second design printed thereon;

FIG. 4 depicts a writeable surface covering applied to a wall; and

FIG. 5 depicts the writeable surface covering of FIG. 3 with user content applied to the writeable surface covering.

### DETAILED DESCRIPTION OF THE PREFERRED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

Specific quantities (spatial dimensions, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

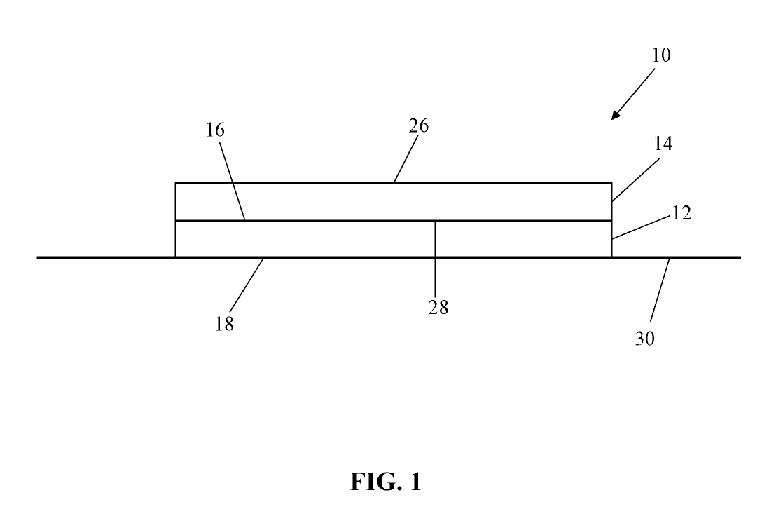

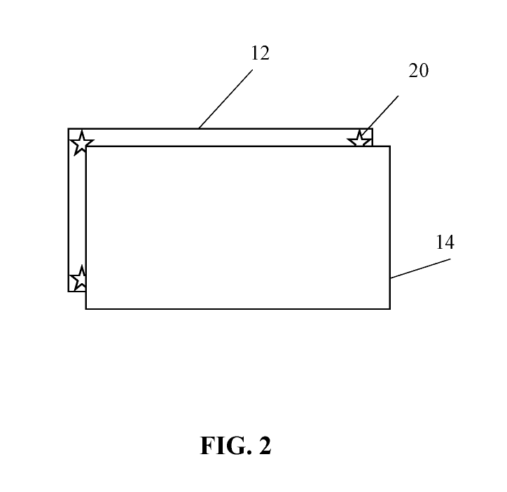

Referring to FIGS. 1 and 2, an embodiment of a writeable surface covering 10 comprises a base layer 12 and a transparent layer 14 applied to the base layer 12. The base layer 12 includes a first surface 16 and a second surface 18 opposite the first surface. In some embodiments, the base layer optionally includes an adhesive applied between the second surface and a release paper or “backing.” In some embodiments, the release paper is a wax paper or other non-stick paper. In other embodiments, adhesive, such as, for example, wallpaper paste, is applied to the second surface and release paper is omitted. In some embodiments, the base layer is a cast film. In preferred embodiments, the base layer is white. An exemplary base layer is the Controltac™ Graphic Film 180-10 White offered by 3M Company, although other products are suitable as well.

Graphical content 20 is applied to the first surface 16 of the base layer 12. In some embodiments, the graphical content 20 is applied by printing black or colored ink, such as, for example, water-soluble inks, gel inks, latex inks, or UV inks, onto the base layer 12 using standard printing techniques. In further embodiments, the graphical content 20 is applied by layering cut shapes or patterns onto the base layer 12, such as vinyl cut lettering. In certain embodiments, the graphical content 20 is applied by both printing and layering cut shapes or patterns onto the base layer 12. In some embodiments, the graphical content 20 is a brand, logo, trademark, or service mark. In other embodiments, the graphical content 20 is words, designs, images, or combinations thereof.

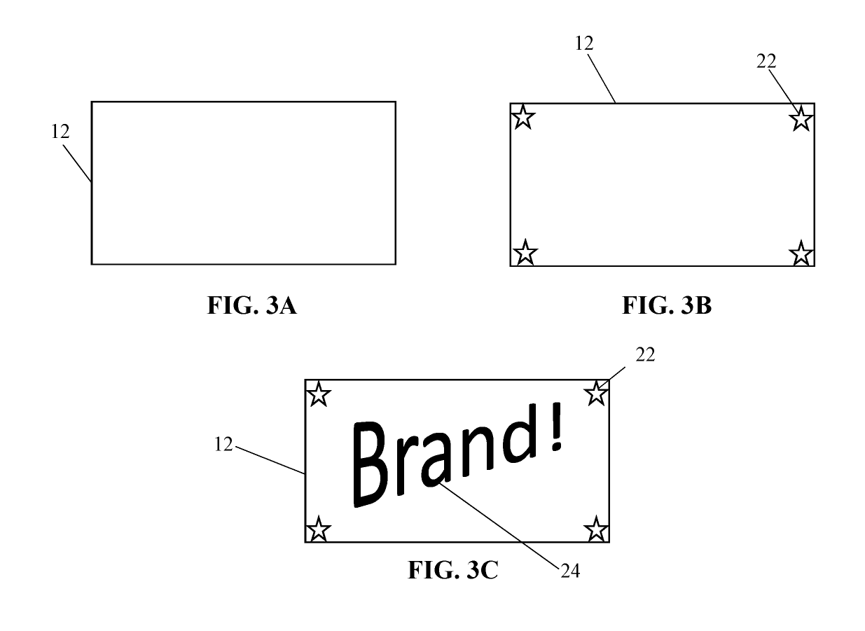

In some embodiments, application of graphical content 20 to the base layer 12 includes multiple application steps. Referring now to FIGS. 3A, 3B and 3C, in some embodiments, the graphical content 20 includes a first design 22 applied to the base layer 12 and a second design 24 subsequently applied to the base layer 12. In some embodiments, the first design 22 may comprise the background of the graphical content 20 and the second design 24 may comprise the foreground of the graphical content 20. FIG. 3A depicts a blank base layer 12. FIG. 3B depicts the base layer 12 of FIG. 3A with a first design 22 printed thereon. FIG. 3C depicts the base layer 12 of FIG. 3B with a second design 24 printed thereon. In some embodiments, a manufacturer may pre-print a variety of first designs on base layers, then allow customers to choose between different base layers with different first designs. The manufacturer may then receive artwork from the customer or work with the customer to develop artwork which will be printed on the base layer as the second design. In other embodiments, the manufacturer may maintain a collection of designs instead of pre-printing first designs on base layers. A customer may select a first design from the collection and provide artwork to the manufacturer or work with the manufacturer to develop artwork which will be printed on the base layer as the second design. The manufacturer will then create a custom writeable surface covering by applying the first design to the base layer then applying the second design to the base layer. In further embodiments, the graphical content may include third or subsequent designs. In certain embodiments, the customer may provide the first design to the manufacturer and select the second design from a collection of designs. In some embodiments, the first and second designs may be applied using different application techniques. For example, the first design may be applied using a gel printer and the second design may be applied by layering vinyl cut lettering atop the first design. Other combinations of techniques may also be used.

Referring again to FIG. 1, the transparent layer 14 includes a front surface 26 and a rear surface 28, the rear surface 28 being attached to the first surface 16. The transparent layer 14 is, in some embodiments, comprised of polyethylene terephthalate (PET) with an ultraviolet (UV) coating on its front surface. The UV coating imparts a “dry erase” property to the transparent layer 14. Commercially available dry erase markers may be used to write or draw on the transparent layer 14, and the writing or drawing later substantially erased from the transparent layer 14. In other embodiments, the transparent layer may be comprised of other polyethylene compounds, polyvinyl chloride, calcium carbonate, kaolinite or other suitable materials known in the art which may or may not include UV coatings as necessary to impart a “dry erase” property to the material. An exemplary transparent layer is the Wipeout™ dry erase hard coat clear laminate offered by Drytac Corporation, although other products are suitable as well.

In practice, graphical content 20 is provided to the manufacturer by a customer, created by the manufacturer according to customer guidelines, selected by the customer from a collection of existing designs, obtained or created by the manufacturer on its own initiative, or a combination thereof. The graphical content 20 is applied to the first surface 16 of the base layer 12 using printing techniques generally known in the art or by layering cut shapes or patterns. The transparent layer 14 is then applied onto the first surface 16 of the base layer 12 using a laminator, the base layer 12 and transparent layer 14 combining to form the writeable surface covering 10. In certain embodiments, the graphical content 20 is printed on the base layer 12 using one of an ink printer, a latex printer and a gel printer. In further embodiments, the graphical content 20 is printed on the base layer 12 using a gel printer. In some embodiments, a gel printer is used for applying graphical content 20 and a cold roll laminator is used for applying the transparent layer 14 to avoid the increased energy usage typically associated with devices utilizing high temperature (e.g., laser printers, hot roll lam inators).

The writeable surface covering 10 disclosed herein may be applied to a support surface 30 using similar techniques as in applying wallpaper. The support surface 30 is typically a wall, but may be a floor or ceiling. In embodiments where the base layer 12 includes an adhesive and release paper, the release paper may be removed and the second surface 18 adhered to the support surface 30. In other embodiments, where the base layer 12 lacks adhesive and release paper, adhesive may be separately applied to the second surface 18, then the second surface 18 adhered to the support surface 30. The writeable surface covering 10 may be applied to the support surface 30 as an integral piece. In other embodiments, the covering 10 may be cut into or manufactured as separate strips of desired widths and the strips applied adjacent to each other on the support surface 30, similar to how strips of wallpaper are applied to a wall. By increasing the number of strips used, writeable surface coverings 10 of any size can be produced.

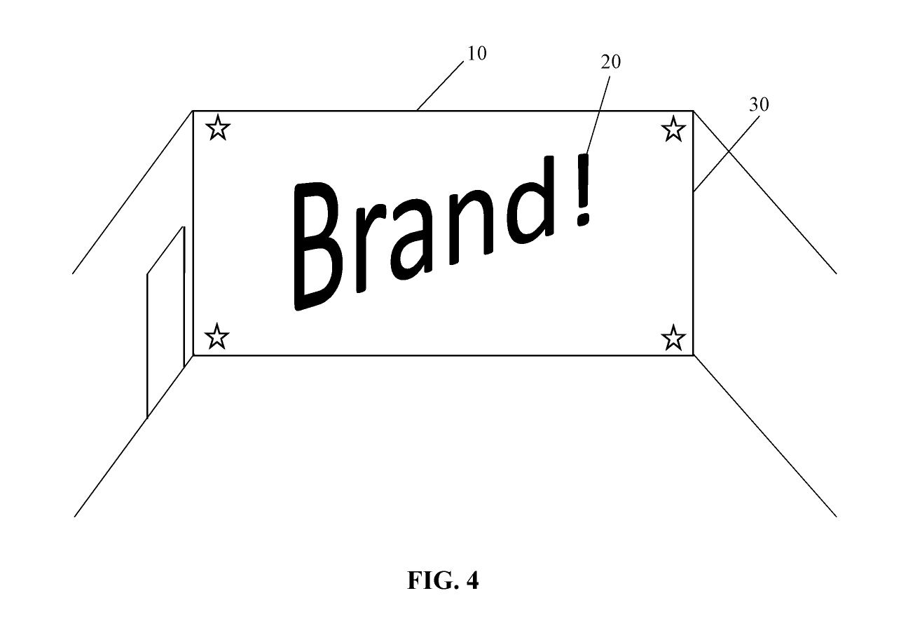

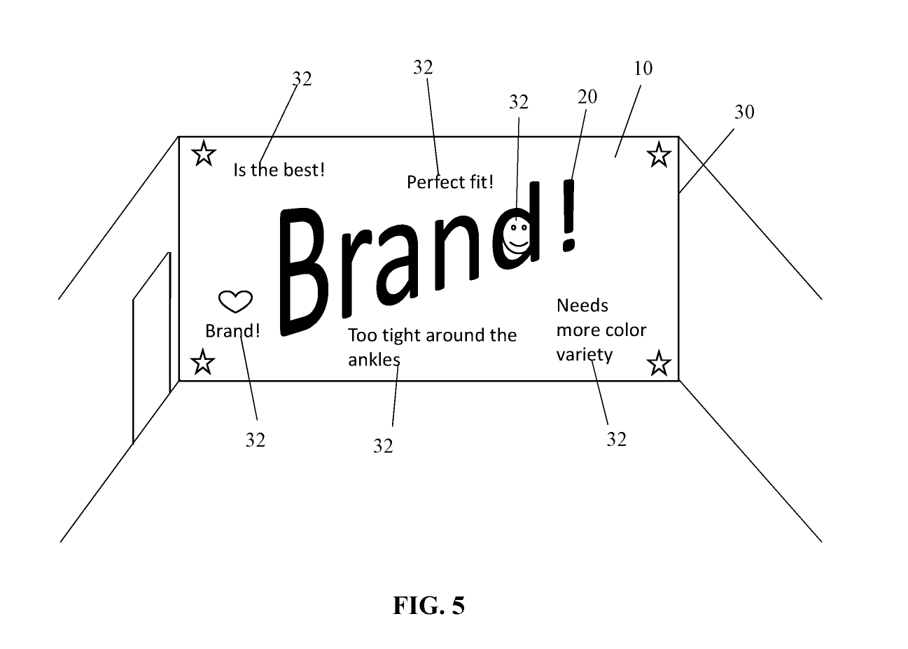

Referring to FIGS. 4 and 5, applying a writeable surface covering 10 displaying graphical content 20 to a support surface 30, such as a wall, accessible to users allows the writeable surface covering 10 to serve as a method of presenting user-interactive graphical content 20. FIG. 4 displays the interior of a room in which a writeable surface covering 10 is applied to, and covers substantially the entirety of, a wall. The writeable surface covering 10 displays graphical content 20, such as the exemplary trademark “BRAND!” and a background design of stars located at the corners of the surface covering 10. FIG. 5 displays the same room and writeable surface covering 10 after users have written or drawn user content 32 on the writeable surface covering 10. In some embodiments, user content 32 comprises user feedback and commentary on the graphical content 20.

Various embodiments of the present invention incorporate a close functional relationship between the graphical content 20 printed on the base layer 14 and the practical reasons for presenting the graphical content 20 in a user interactive manner on a writeable surface covering 10. The writeable surface covering 10 provides a means for displaying graphical content 20 which allows users to interact with the graphical content 20 while not permanently defacing the graphical content 20. Unlike simple dry erase boards with pre-printed calendars or gridlines, the graphical content 20 on writeable surface covering 10 disclosed herein may be customized to elicit desired user content 32. Examples 1-4 below describe interactions and relationships between graphical content and user-added content in various embodiments of the present invention. Examples 5-6 describe methods of selecting or creating graphical content for writeable surface coverings.

Example 1—A company offering a product under the trademark BRAND X wishes to elicit internal feedback regarding its product. The company obtains a customized writeable surface covering wherein the graphical content printed on the base layer is the word “BRAND X.” The writeable surface covering is applied to a wall in a commonly-travelled corridor in the company's office building and writing implements, such as dry erase markers, are provided near the writeable surface covering. Users, such as employees walking along the corridor, may use the writing implements to write or draw their thoughts, comments, feedback and ideas regarding BRAND X product on the writeable surface covering.

Example 2—A company may wish to brainstorm ideas from a limited group of employees for a company initiative referred to as “Project Wildcat.” The company obtains a customized writeable surface covering wherein the graphical content printed on the base layer is the words “Project Wildcat” and a brief summary of the purpose of the project. The writeable surface covering is applied to an interior wall in a conference room in the company's office building and substantially covers the entire wall. The company provides means for applying user content to the writeable surface covering, such as dry erase markers, in proximity to the writeable surface covering. Users, such as company employees with access to the conference room, may write or draw their thoughts, comments, feedback, and ideas to improve, facilitate, or expedite Project Wildcat on the writeable surface covering.

Example 3—A young basketball player dreams of playing for a specific professional basketball team. The player obtains a customized writeable surface covering wherein the graphical content printed on the base layer is the professional basketball team's logo. The player may write inspirational messages, goals, or information regarding the team's statistics on the writeable surface covering. As the player completes goals or the team's statistics change, the player may erase older user content and write new goals or new statistics on the writeable surface covering.

Example 4—A company considering adopting a new logo wishes to elicit feedback from the general public regarding several potential new logos. The company obtains a customized writeable surface covering wherein the graphical content printed on the base layer is renditions of each of the potential logos together with the text “Which is your favorite?” The writeable surface covering is applied to a support surface accessible to the public, such a wall in a mall or other indoor shopping center, and writing implements, such as dry erase markers, are provided near the writeable surface covering. Users, such as individuals visiting the shopping center, may use the writing implements to write their opinions regarding the displayed potential logos. Employees or other representatives of the company may periodically view user content added to the writeable surface covering to learn which logo is the most popular, to erase offensive or otherwise inappropriate user content, or to erase user content to provide clean space for additional user content to be added.

Example 5—A company wishes to obtain a customized writeable surface covering. The company contacts a manufacturer of customized writeable surface coverings and requests a covering displaying a bear. The manufacturer's in-house art team creates artwork displaying a bear, presents the artwork to the customer, and modifies the artwork based on feedback from the company. Once the bear artwork meets the company's approval, the manufacturer applies the bear artwork to a base layer by printing or using cut film, then applies a transparent layer to the base layer to create a customized writeable surface covering, which is then delivered to the company.

Example 6—A company wishes to obtain a customized writeable surface covering displaying the company's artwork in combination with artwork provided by a manufacturer of customized writeable surface coverings. The company selects artwork provided by the manufacturer to serve as the background of the graphical content. The company then provides its own artwork to serve as the foreground of the graphical content. The manufacturer provides a base layer, prints its artwork on the base layer as a first design, then prints the company's artwork as a second design atop the manufacturer's artwork. The manufacturer then applies a transparent layer to the base layer to create a customized writeable surface covering, which is then delivered to the company.

Example 7—A travel agency wishes to obtain a customized writeable surface covering displaying the company's mission statement in combination with a digital photograph of a popular beach vacation location. The company provides a manufacturer of customized writeable surface coverings with the photograph and mission statement. The manufacturer provides a base layer, prints the digital photograph on the base layer as a first design, then applies the lettering of the mission statement using cut film as a second design atop the first design. The manufacturer then applies a transparent layer to the base layer to create a customized writeable surface covering, which is then delivered to the travel agency.

The foregoing detailed description is given primarily for clearness of understanding and no unnecessary limitations are to be understood therefrom, for modifications can be made by those skilled in the art upon reading this disclosure and may be made without departing from the spirit of the invention. Although specific spatial dimensions are stated herein, such specific quantities are presented as examples only.

What is claimed is:

1). A method of presenting user-interactive graphical content, the method comprising:
providing a writeable surface covering displaying graphical content;
applying the writeable surface to a support surface accessible to a user; and
providing means for applying user content to the writeable surface covering.

2). The method of claim 1, wherein the writeable surface covering includes
a base layer including a first surface and a second surface opposite the first surface; and
a transparent layer including a front surface and a rear surface, the rear surface attached to the first surface of the base layer.

3). The method of claim 2, wherein the graphical content is printed on the first surface of the base layer prior to attachment of the transparent layer to the base layer.

4). The method of claim 2, wherein applying the writeable surface covering to the support surface comprises affixing the second surface of the base layer to the support surface.

5). The method of claim 4, wherein affixing the second surface of the base layer to the support surface comprises adhering the second surface of the base layer to the support surface.

6). The method of claim 1, wherein the support surface is a wall.

7). The method of claim 6, wherein the support surface is located in a commercial building.

8). The method of claim 1, wherein the graphical content includes a first design and a second design.

9). The method of claim 8, wherein the first design is selected from a collection of first designs.

10). The method of claim 8, wherein the writeable surface covering includes
a base layer including a first surface and a second surface opposite the first surface; and
a transparent layer including a front surface and a rear surface, the rear surface attached to the first surface of the base layer, and
wherein the transparent layer is applied to the base layer after the second design is applied on the first surface, and
wherein the second design is applied on the first surface after the first design is applied on the first surface.

11). The method of claim 1, wherein the user content includes words, indicia or drawings written on the writeable surface covering.

12). The method of claim 1, wherein the means for applying user content includes writing implements.

13). The method of claim 12, wherein the writing implements are dry erase markers.

14). The method of claim 1, wherein the user content is erasable from the writeable surface covering.

15). A method of eliciting feedback on graphical content, comprising:
forming a writeable surface covering by printing graphical content on a first surface of a base layer, then applying a transparent layer to the first surface;
adhering the writeable surface covering to a support surface accessible to a user; and
providing means for applying user content to the writeable surface covering.

16). The method of claim 16, wherein the base layer is a cast film.

17). The method of claim 16, wherein the transparent layer is comprised of polyethylene terephthalate.

18). The method of claim 15, wherein the writeable surface covering is sized to substantially cover the entirety of the support surface.

19). The method of claim 15, wherein the graphical content includes a first design and a second design, wherein the second design is printed on the base layer after the first design is printed on the base layer.

20). The method of claim 15, wherein the graphical content is printed using a gel printer.
